(19) United States
(12) Patent Application Publication
(10) Pub. No.: US 2011/0301941 A1
(43) Pub. Date: Dec. 8, 2011

(54) NATURAL LANGUAGE PROCESSING METHOD AND SYSTEM

(75) Inventor: Petrus Matheus Godefridus De Vocht, Paramata (NZ)

(73) Assignee: SYL RESEARCH LIMITED, Wellington (NZ)

(21) Appl. No.: 12/996,742

(22) PCT Filed: Mar. 18, 2010
(86) PCT No.: PCT/NZ2010/000046

§ 371 Date: Aug. 16, 2011

(30) Foreign Application Priority Data
Mar. 20, 2009 (NZ) 575720
Dec. 10, 2009 (NZ) 581848

(51) Int. Cl. G06F 17/27

(52) U.S. Cl. 704/9

(57) ABSTRACT

A computer implemented natural language processing method, the method including the steps of: analysing a sentence string within textual information to determine sub-components of the sentence string, assigning one or more unique tokens to each determined sub-component, determining a probability of use that a determined sub-component has one or more specific meanings, based on the determined probability of use, creating a valid set of unique tokens that are associated with the sentence string, and linking verb sub-components associated with one or more of the unique tokens in the valid set of unique tokens to a pre-defined limited sub-set of verbs to create an identification tuple that maps onto the sub-set of verbs.

### FIELD OF THE INVENTION

The present invention relates to a natural language processing method and system. In particular, the present invention relates to a natural language processing system and method that creates an identification tuple for sentence structures and links verbs within the sentence structures to a limited sub-set of verbs to identify other relevant sentence structures.

### BACKGROUND

Natural language processing (NLP) systems are used in an attempt to understand the meaning behind natural language statements and queries in order to identify a more accurate response, whether that response is finding a document, finding a passage in a document, creating defined metadata, tracking statements made about defined subject matter from a source, finding a pertinent reference, answering a question, requesting further information, or performing any other function based on the statement or query.

NLP systems have attempted to move away from using a strict literal understanding of the specific words used in language and instead apply rules in order to create a more natural understanding of the words used. NLP systems may be incorporated within searching systems as a replacement of, or a supplement to, strict statistical analysis of document text and search queries.

Generally, in prior known search systems, a search query is used to identify potentially relevant documents and then to rank those documents based on how closely the search query matches the documents. This can be a lengthy process as the query needs to be assessed against all known documents, and then the identified documents are required to be ranked, where the ranking criteria may not be associated with the correct semantic or syntactic use of the search query terms or associated portions of the documents being searched. Further, some prior known systems merely rank the entire documents based on the search query, and do not provide any method of ranking or analysing individual statements within those documents.

Further, prior known search systems tend to rely on the user phrasing a question in broad terms, or phrasing a question using multiple terms, in order to capture as many relevant documents in the search process as possible. Thus, if the query is not phrased by the user in the correct manner, or the words that match closely with the answer are not used, this may result in important documents being excluded from the results of the query.

Further, in known systems, it is standard for search queries to merely return answers specifically associated with the query rather than determining answers through related facts. For example, one document being analysed to find an answer to a query may only provide a partial answer to the query, whereas an entry in a further document may provide the missing information to more fully answer the query. Known systems do not adequately address this problem.

Further, some known search systems enable faceted search, also called faceted navigation or faceted browsing, which enable the user to filter search results or explore related information. Each facet corresponds to the possible values of defined metadata or of entities (including people, places, things, or concepts) associated to the document. In known systems, facets must be pre-determined and available as additional metadata that accompanies the document or is stored in an external repository such as a database. Known systems do not generally derive facets from analysis of the meaning of information supplied in the content of documents.

In one known system, disclosed in European patent EP0597630B, a method for resolution of natural-language queries against full-text databases is provided. This document describes a system that incorporates a concept detection mechanism to improve the search results. However, the mechanism used relies on a very detailed ranking algorithm and the definition of concept relationships for words being analysed in the full text databases. Further, the system utilizes a laborious linear process whereby the document is parsed, all words are identified, and then subsequently the analysis is performed in order to rank the documents found. The analysis can therefore be a lengthy process. Further, the system requires a large amount of analytical processing power in order to perform accurate, detailed and fast searches in real time. In addition, only specific documents are identified during the search process, rather than specific sentence structures within the document.

PCT application WO 2006/042028 discloses a natural language question answering system and method utilising multi-modal logic. The system includes a complex system of logic modules to analyse the relationship between query logic and developed answer logic. The system iteratively applies various rules to adjust the determined relationship and to provide a set of ranked answers. However, the system only selects what it determines are key words in the query, which may result in missing important query information. Further, the system does not analyse and link sentence structures in documents prior to any searching being carried out but relies on analysing the question and answer logic at the same time. Therefore, upon a query being submitted, the system is required to carry out a lengthy analysis on each separate component in the documents to determine whether they can be associated with the query.

An object of the present invention is to provide a system and method that efficiently determines whether sentence structures are similar in context.

A further object of the present invention is to associate, link or match different sentence structures in the same or different text sources and provide an indication of how closely they relate.

The present invention aims to overcome, or at least alleviate, some or all of the afore-mentioned problems, or to at least provide the public with a useful choice.

### SUMMARY OF THE INVENTION

The present invention provides a system and method that analyses sentence structures semantically and syntactically to determine an unambiguous representation of that sentence structure. Further, the present invention relates or associates one or more determined verbs in the sentence structure to a sub-set of verbs in order to relate or associate the sentence structure with further sentence structures in an efficient manner. The system or method may provide a matching score based on how closely the sentence structures relate. The sentence structures may be located within a single document or in multiple documents. The documents may be stored in the same location on the same device or on different storage devices, or may be stored in different locations on same/different device types.

According to one aspect, the present invention provides a computer implemented natural language processing method, the method including the steps of: analysing a sentence string within textual information to determine sub-components of the sentence string, assigning one or more unique tokens to each determined sub-component, determining a probability of use that a determined sub-component has one or more specific meanings, based on the determined probability of use, creating a valid set of unique tokens that are associated with the sentence string, and linking verb sub-components associated with one or more of the unique tokens in the valid set of unique tokens to a pre-defined limited sub-set of verbs to create an identification tuple that maps onto the sub-set of verbs.

According to a further aspect, the present invention provides a natural language processing system including: a text processing module arranged to analyse a sentence string within textual information to determine sub-components of the sentence string, a parsing and semantic processing module arranged to assign one or more unique tokens to each determined sub-component, determine a probability of use that a determined sub-component has one or more specific meanings, and based on the determined probability of use, create a valid set of unique tokens that are associated with the sentence string, and a lexicon module arranged to contain links for each verb sub-component such that each link associates a verb sub-component with a pre-defined limited sub-set of verbs to enable the parsing and logic module to create an identification tuple that maps onto the sub-set of verbs.

### BRIEF DESCRIPTION OF THE DRAWINGS

Embodiments of the present invention will now be described, by way of example only, with reference to the accompanying drawings, in which:

FIG. 1 shows a logical arrangement of integrated system components according to an embodiment of the present invention;

FIG. 2 shows an inference engine according to an embodiment of the present invention;

FIG. 3 shows a high level view of the processes and associated linguistic structures of a system according to an embodiment of the present invention;

FIG. 4 shows a conceptual view of the system operation according to an embodiment of the present invention;

FIG. 5 shows a detailed component/module view of the system according to an embodiment of the present invention;

FIG. 6A shows a high-level logical view of the software components of the system according to an embodiment of the present invention;

FIG. 6B shows a high level view of the communication channels between components of the system according to an embodiment of the present invention.

FIG. 7 shows a detailed breakdown of the structure of the system according to an embodiment of the present invention;

FIG. 8 shows a detailed component/module view of the system according to a further embodiment of the present invention;

FIG. 9 shows a flow diagram of a method according to an embodiment of the present invention;

FIG. 10 shows a detailed component/module view of the system according to a further embodiment of the present invention.

### DETAILED DESCRIPTION OF THE INVENTION

The invention as described may be applied to a number of different technical fields. For example, the invention may be applied to search engines such as enterprise search engines, Internet search engines, local database and external database search engines, document server search engines, data store search engines, digital library search engines etc. Also, the invention may be applied to Artificial Intelligence (AI) systems, where the system is equivalent to a long term associative memory. In addition, the invention may be applied to data summary systems, which include focussed meta data creation, and entity tracking. Other relevant systems include, but are not limited to, question and answer systems, automated help desk systems and intelligent agent systems.

### First Embodiment

The herein described embodiment is aimed at providing a reduced overhead in systems related to query definition and interpretation of search results. This in turn may translate to a higher quality of search results and greater efficiency in related applications.

It will be understood that any references to processing steps described herein are implemented using the modules of the system as described and shown in the accompanying figures.

In this embodiment, the system is a semantic logic/search engine.

It will be understood that other suitable alternative systems may be used to implement the invention, such as, for example, consumer appliance systems (e.g. intelligent assistants), human assistant systems (e.g. artificial advisory systems, help desk agents, search agents, knowledge management agents) in a wide area of fields (e.g. hospitals, lawyers, military, etc.). More specifically, intelligent appliances (e.g. an artificial assistant ‘inside’ a cell-phone or PDA device, or a household helper intelligence), artificial advisory systems, military intelligence systems, and human assisted/assisting intelligence, for example.

The system catalogues data that is presented to it as written English or keyword form, indexes that data, and allows a relevant set of queries to be applied against that data.

The system develops a broad set of queries (based on semantic equivalence) that are to be applied to the data. The system produces relevancy-ranked answers and inferences based on the data and questions.

The system could, for example, provide a ‘research function’. In this scenario, the system would return, from a single query, a ranked listing of relevant research material and indicate highlights on the most relevant areas (either by document, section, page, or line or any combination thereof). The output is based on semantic and natural language interpretation and so may replace, or at least work in combination with, an iterative keyword search.

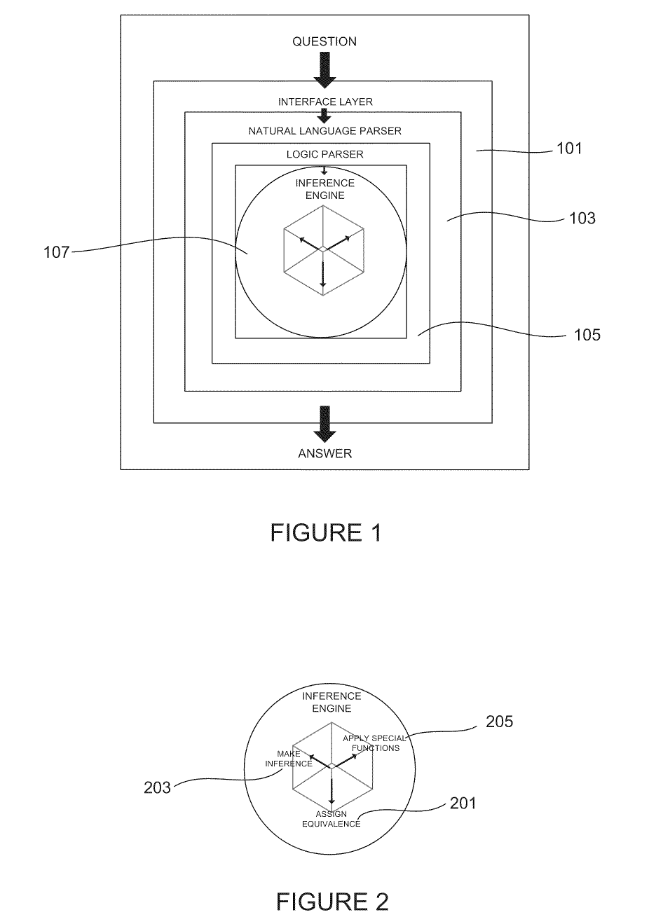

Therefore, the core components of the system provide a unique method of parsing, storing, and matching data-sets so that highly relevant information can be returned for a natural language query against a defined data source. This functionality is achieved with a number of integrated system components, which are shown logically in FIG. 1.

The system components include an Interface layer 101, a natural language parser 103, a logic parser 105 and an inference engine 107. The system receives a question as an input at the interface layer, and outputs an answer to the question via the inference engine.

The interface mechanisms of the interface layer provide connectivity to the data source and for the product users. The interface layer also includes one or more filters to process various data types which may be encountered, such as, for example, Word documents, PDFs, HTML, XML, and Databases.

It will be understood that a variety of different input sources are possible. For example, the input data may be retrieved from a database system (standalone, distributed or integrated), a document retrieval system, a digital library, a document server, a scanning device, an e-mail interface device, a peer to peer interface device, or a file transfer protocol interface device. Further, the input source may also be natural language speech via any suitable input device such as a microphone, for example.

The retrieved document may be parsed and converted to at least one of an HTML and XHTML format before analysis of the document is performed. For example, external documents may be converted to a XHTML format to detect headers/headings, tables, or paragraphs, for example. This may be used to identifying sentence strings and unstructured data, for example tabular data etc., as will be explained in more detail below. The filters in the interface layer may include templates to process structures such as tables.

It will be understood that, as an alternative, other forms of implementation may be used where the text and available metadata (headings, tables etc) are parsed.

The natural language parser of the system is used to identify the parts-of-speech and sentence boundaries for all material in the target data store. This forms a syntactic analysis step.

Following the syntactic analysis, semantic analysis is performed using statistical methods as described herein. Further, the results of the semantic analysis can be fed back to the syntactic analysis modules to assist in modifying the determined syntax.

The logic parser of the system is used to apply additional parsing to ensure that all subject-verb-object combinations, for example, taken from sentences and clauses in the data are identified and structured for further processing by the Inference engine.

The inference engine of the system carries out this ‘further processing’. This can be considered to consist of the three dimensions as shown in FIG. 2. These consist of assigning equivalence 201 through the use of semantic relationships, making inferences 203 and applying special functions 205 as will be explained in more detail below. As each of these dimensions are developed further, the ‘smarter’ and more relevant to a specific application the system becomes.

The system therefore provides a semantic search system that will accept precision queries. The user is able to precisely specify the information or answer that they are attempting to retrieve using natural language. For example, the question may be framed specifically according to the business area of the user.

The system may then provide a highly relevant response that reflects the type of question being asked, such as, Who, Where, When, etc. Further, the system may enhance the ease and speed of use of such tools by reducing the required level of user expertise (or demands on connecting systems) for both query and interpretation of results. The system may make it possible for a wider range of users and systems to interrogate complex data stores and to do so more rapidly.

Therefore, the system processes natural language inputs (such as text and questions about that text, for example) and provides a natural language output (for example, answers to the questions) based on the input. This is achieved by accurately parsing the natural language inputs (query or source data), received from a person or system, to recognise ‘parts of speech’ (POS) using syntactic analysis, and then undertaking sophisticated semantic matching steps to identify information most relevant to the nature of the query.

One particular concept the system uses is to relate similar sentence structures in documents in a data store using defined syntactic, semantic and probability of use data for a large set of words in conjunction with references to a limited sub-set or grouping of verbs that encompass the meaning of most existing verbs. The sub-set of verbs is a group of linked or related verbs that have a similar or identical meaning.

A natural language query is analysed in a similar way to the analysis of the sentence structures above. After the analysis of the query, the system determines and identifies which of the sentence structures in the data store are applicable, based on defined probability rules. The system may either analyse all documents in the data store prior to a search query being analysed, or may alternatively analyse the data store after a search query is analysed. In the first case, the results of the analysis may be stored and used during the query stage. In the second case, the analysis of the stored data is carried out in a dynamic manner.

By identifying at least one applicable or associated sentence structure in the data store or document that relates to the query, all similar and related sentence structures may also be identified either due to the initial processing that was carried out on the documents prior to the query, or due to the processing of the data or documents carried out at the time of the query.

The linguistic data structures and core processing of the system will now be described using a simple example.

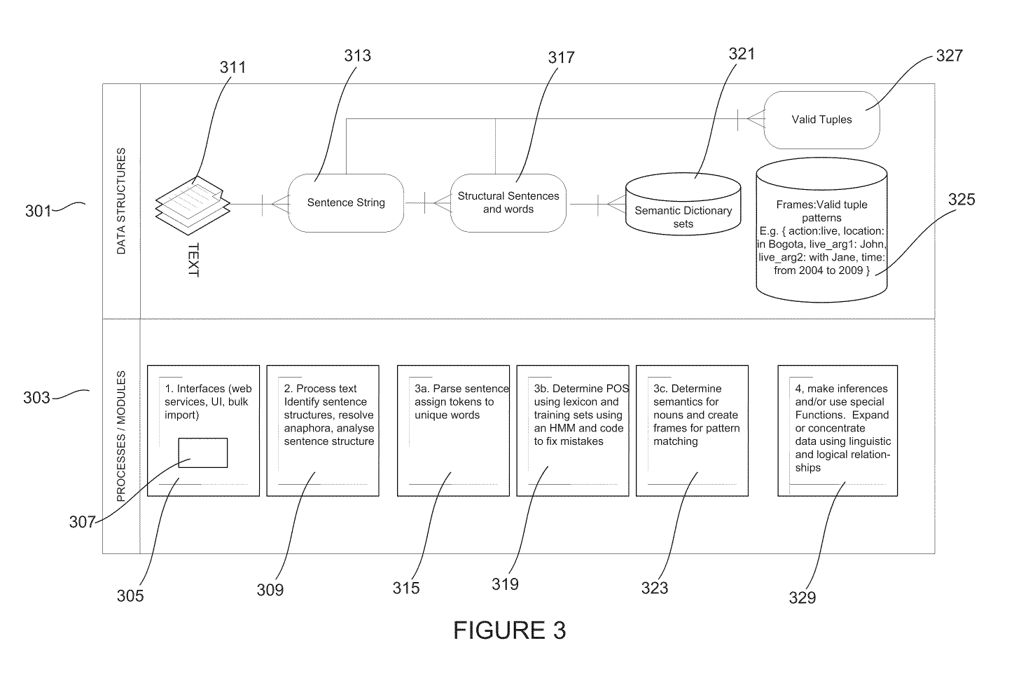

The system assumes the received natural language statement is an unambiguous representation and then marks-up the natural language with syntactic and semantic information (including probabilities) and minimal logic operators (like ‘and’ and ‘or’, and ‘implies’) to create a knowledge representation that closely resembles the original sentence. That is, the original text with identifying tokens is used to represent the text or natural language statements. The natural language statements may be part of text within a document, or part of a search query, for example. The processes and associated linguistic structures of the system are shown at a high level in FIG. 3.

At one level, the data structures 301 are shown as they progress through the different stages of processing. At another level, the various processes and modules 303 used are shown.

As briefly explained above, the interface module process 305 provides connectivity to the data source(s) and for the system users. That is, the interface module of the system includes interface modules for web services, user interfaces and bulk imports. The interface module also includes a filter module for the filter module process 307, which processes various data types which may be encountered (e.g. word documents or PDF).

A text process module controls a text process 309 that identifies sentence structures, resolves anaphora and analyses the identified sentence structures. It is used to process documentation and textual data fields 311 into a set of sentences 313. This is done by identifying sentence boundaries (for example full stops and capitals) and other sentence constructs. The system processes these sentences as text strings, i.e. sentence strings 313.

A set of parsing and semantic logic processes are then performed by the parsing and semantic processing module within the system.

A sentence parsing and semantic processing module performs a parsing process 315 that breaks a processed sentence into simple sentences and individual words 317. This step uses the analysis performed by the text process module described above in order to, for example, interpret conjunctions and anaphora. The individual words are represented as tokens which have been uniquely assigned to each English word. It will be understood that the system may be adapted to process words and text, regardless of the type of script in which the words or text are represented, in other languages in a similar manner as herein described. A single word can be assigned multiple tokens in case of ambiguity and assigned a probability with each assignment. The sum of the word probability=1, i.e. Σp(w)=1.

The next process carried out by the parsing and semantic processing module is the determination of a part of speech (per word) and valid sentence options 319. The system utilises a pre-loaded and indexed entry 321 for all homonyms for most English words, i.e. a lexicon. Each of these entries has an associated table of linguistic details with it which defines the part-of-speech, semantic relations, semantic set, word category equivalence as described in more detail below. Each entry also has a probability of use value assigned for the part-of-speech. These probabilities have been either pre-set (or ‘learnt’) based on a large training set of text applied to the system, and may also be adapted as the system is used. Each word also has a set of semantic possibilities with probabilities. That is, these possibilities are used by an algorithm to assign probabilities of use for each possibility.

Therefore, all nouns that are spelled alike but have different meanings are grouped together. For example, the word “Bank: Financial Institution” is grouped with “Bank: River side” as well as with all other uses of the word bank. This provides a sub-set of nouns that are unrelated but are linked by their spelling.

It will be understood that, as an alternative, the system may be modified to store word data related to any other language.

For each word in a sentence the parsing and semantic processing module of the system uses the part-of-speech and probability data in conjunction with the Hidden Markov Model and Viterbi Algorithm to assign a probability to the related homonyms (and therefore associated part-of-speech). The system is therefore arranged to determine one, or a limited number, of valid sentence structures. These valid sentence structures are represented using a series of tokens that represent the individual words or parts-of-speech forming the sentence string. It will be understood that there may be more than one valid sentence structure for a sentence string as some sentence strings may be ambiguous, however the assignment of a probability value using the methodology described below enables the system to determine a hierarchy of the most relevant meanings for the sentence strings, and so determine which of the valid sentence structures are likely to be more relevant.

Therefore, the process herein described first performs syntactical analysis to determine sentence structures and the type of words within those structures. The syntactic step is followed up by performing semantic analysis on words that are ambiguous.

The system creates logic statements based on verb actions and frames (identification tuple). The frame holds the additional parameters to the verb (e.g. locations, agents, subjects, objects, times and dates).

Frames are then matched with other frames through a pattern matching process, as described below. Linguistic relationships (e.g. synonyms, entailment (verb synonyms), part relationships (meronyms and hypernyms)) are used to match frames assigning relevance weights to each frame.

A frame defines a valid, i.e. potentially meaningful, logic statement 323. For example, a triplet 327 may be a subject, verb, object (SVO) combination, such as:

{Subject: Part-of-Speech+Semantic-Set;
Verb;
Object: Part-of-Speech+Semantic Set}.

As a further example, a frame 325 may exist which models that one living thing can own another living thing as follows:

{Subject: Noun+Living Thing;
Verb: owns;
Object: Noun+Living thing}.

This frame could be modified to disallow an animal from owning a person by applying an exception for names or personal pronouns for the ‘subject’ entry.

The system assigns probability to valid tuples, and uses this probability and syntactic (based on POS) and semantic restrictions to select the most likely valid tuple as the candidate meaning for the simple sentence. Probability can be calculated in a number of ways as described in more detail below.

In this way a set of ranked valid logic statements (identification tuples) representing each simple sentence are made available for further processing by the Inference engine. The table below shows some of the details associated with each unique word/meaning combination.

| Details | Description |
|---|---|
| Token | Unique word/meaning identifier |
| Part-of-Speech | E.g. Noun, Verb, Pronoun etc |
| Semantic Relations | Mostly pointers to other words, including: |
| | synset pointers, hyponym pointers, instance |
| | pointers, entailment pointers, meronyms |
| | (substance and part), cause pointers, |
| | attribute relation pointers, antonym pointers, |
| | pertainym pointers, hypernym pointers, |
| | holonym pointers . Others may also be used, or |
| | added. |
| Semantic Set | Mapping to Semantic Set. In this |
| | embodiment, there are around 50 of these, |
| | however it will be understood that there may |
| | be provided more or less; for example Noun- |
| | Plants, Noun-Grouping of People etc. |
| Semantic Probability | Probability of this word/homonym being the |
| | option in use; based on a training set of data. |

Prior to analysing the sentence strings in documents, a probability value is calculated for each word from a training set to create a linguistic table, which forms the lexicon.

The training set creates the values of the Hidden Markov Model (HMM) statistical table. The training set is a set of sentences which have been manually or machine tagged. The tagging may be performed by the creator or user of the system, or by third parties, such as by using the British National set.

For example, during the training of the system, the system may receive marked up POS from a third party as well as sentences created by the creator of the system. These are applied to the training software portion of the system which determines probabilities for each POS from existing English text. The training software then creates the HMM model and lexicon with probabilities for each word in the lexicon (for each POS).

For example, bank (noun)=90% probability, bank (verb)=10% probability.

After training is complete, when the system is performing a search function, for example, the syntactic parses with the HMM and lexicon analyses the incoming text from external sources.

For example, for the incoming text “in the bank”, the POS are:

Preposition (In); Determiner (The); Noun or Verb (Bank)

The probability of ‘In’ being a preposition is 100%. The probability of ‘The’ being a determiner is 100%. The probability of ‘Bank’ being a noun is 90% and a verb 10%.

The HMM includes the following probabilities:

P(determiner+noun)=99%

P(determiner+verb)=1%

The probability that ‘bank’ is a noun is calculated as 90%×99%, whereas the probability that it is a verb is 10%×1%. Therefore, it is highly likely that bank in this case is a noun POS.

The probability value in the table determines the likelihood that the word is a particular “part of speech”, i.e. that the word is a noun, verb etc. The probability value may be continually updated when receiving further documents, but is initially determined using a training set of data. Therefore, every unique word is assigned a probability value for each of its uses.

Viterbi and Markov models are used to determine syntactic relationships (i.e. parts of speech). All natural language analysis follows the steps of determining the sentence boundaries, syntactic analysis (Viterbi, Markov model, probabilities), and semantic analysis (determining exact senses of words (e.g. if “bank” is used, which sense of “bank” is it (the side of a river, or the money place)).

A unique lexicon structure is therefore utilised throughout the system. That is, tokens are used to represent or refer to more complex structures. These structures may consist of semantic relationships; for example, synonyms, semantic meaning, part of speech, context usage probability (i.e. how likely it is that in terms of semantics this particular meaning is assigned a probability, but all alternatives are kept for use in the semantic phase) and probability of part of speech.

The lexicon contains all verb synonyms (entailment) for each verb. Within the lexicon entry for each verb, a list of synonym verbs is provided. These entries provide a link between any verb that is detected within a text string (whether it is in a query or in a document in a data store, for example) and a limited sub-set of verbs, where these verbs are at least associated with the detected verb. For example, if the verb detected is “bark”, the entry for bark provides a link to other associated verb entries that relate to a “communication process”, as in a dog barking. That is, the entry provides a link to the verb synonyms of the detected verb, where those verb synonyms relate to a limited sub-set of verbs. In this way, it becomes possible to easily reference any related verb to the detected verb through the use of a limited sub-set of verbs (when compared to the total number of possible verbs). The linking between verbs may then be controlled to enable the system to be adapted for specific uses by broadening or narrowing the number of related synonyms for the verbs.

Further, concepts consisting of multiple words (e.g. “New York” which really consists of two words) may be based on the first word. Therefore, the system may parse sentences by looking n-words (where n=1 or more) ahead with any concept.

The inference engine carries out the ‘further processing’ 329 as mentioned above. This includes the following three dimensions:

Use Semantic Relations: The System has a mapping of relevant semantic relations (e.g. equivalence or opposites). These mappings can be used to broaden or interpret the meaning of the logic statements.

Make Inference: The System may be able to infer additional relationships based on available rules or consensus data. For example, an inference may be as simple as “matches light candles” or as complex as applying domain specific relationships.

Apply Special Functions, where required: Special functions may be included in the system and used when the system detects the need for their use. These special functions may be created and added to the system at any time in order to enhance the system. When operating, the system receives, as an input, questions and data via the interface layer. The system then parses and processes the elements of language (by making semantic linkages, inferences, and applying ‘special functions’) to derive meaning before presenting specific and relevant responses. For example, the system response may be to provide an answer to a natural language question being asked of a data store.

One example of a special function that the system can apply is the ability to provide aggregations information. This information may be used to supply answers to quantity queries such as ‘how many . . . ?”, etc. Further, these areas of text may also be re-processed based on information obtained from successfully processed/related areas of text.

The system therefore applies syntactic analysis first, and processes unknown words afterwards. That is, the system first detects the words within the sentence structures using syntactic analysis, and subsequently performs further analysis, such as semantic analysis for example, on the detected word if the meaning of the detected word is not clear. This can significantly reduce overheads in the form of reduced processing time and power when compared to prior known systems.

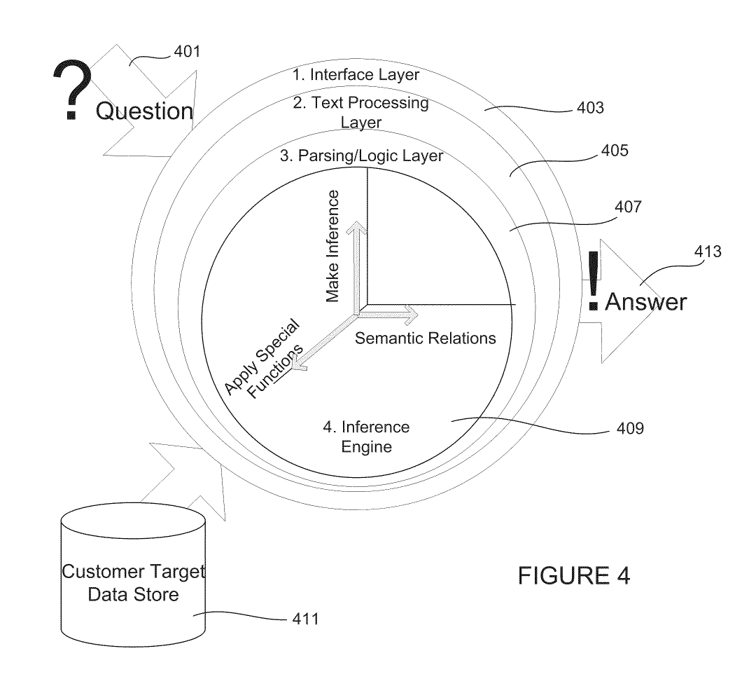

FIG. 4 shows a further conceptual view of the system operation. A question 401 is input via the interface layer 403. The interface layer is in communication with the text processing layer 405. The text processing layer is in communication with the parsing logic layer 407. The parsing logic layer is in communication with the inference engine 409. The inference engine operates based on the three dimensions: semantic relations; make inference; apply special functions. The system retrieves data from the customer target data store 411. Answers 413 are fed out of the system.

Additional support processes are also available to support the operation of the system, and include probability management, index management, accumulated error rate management, and overall “application specific” tuning.

With regard to probability management, the system may retain and manage low probability word or tuple result options in situations where a user requires a full and less specific result. Further, the system may manage high probability result options where these were not determined to be the highest probability result(s), but are still considered to be relevant to the user's query. The probability management module of the system may include adaptable or configurable levels of acceptable probability based on specific applications resulting in the system varying how the result information is provided to the user, or otherwise made available.

Regarding Index Management, the system includes an index management system that enables the system to index semantic relations, such as, for example, synonym, hyponym, meronym, hypernym, holonym relationships.

The Accumulated Error Rate Management module may be used to monitor and/or control, at various steps of the process, errors in parsing or interpretation. For example, errors may arise when performing the following functions: Processing of text to sentences; Parsing of sentences to simple sentences and word tokens; Pre-calculation of Part-of-Speech probability; Determining the semantic relations and verb equivalence for each word; Matching to a Frame, if the relevant valid Frame is not included; Selecting the valid Frame. The system includes pre-defined steps to counteract the errors that occur. Where errors are occurring at regular intervals for a specific word token or part-of-speech, a warning may be issued to a system administrator to investigate the error in order to rectify any incorrect or invalid relationships, definitions etc

The system further enables an Overall ‘Application Specific’ Tuning methodology. That is, for specific real-world applications the probability assessment, accumulated error rate, and overall system performance is required to be acceptable for that application. There is usually a trade-off between these items. For more sophisticated applications a more sophisticated (or custom) probability algorithms, indexing, and error rate management method will be required. For example, it may be necessary in some circumstances to provide detailed tracking of text which could not be fully parsed, or which returned only low-probability valid tuples.

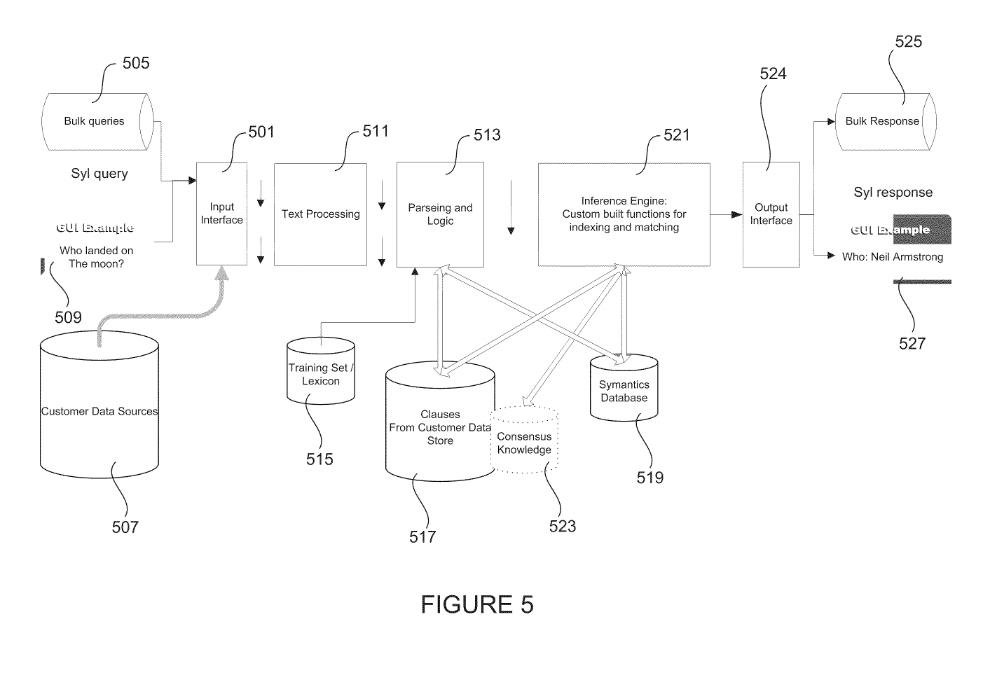

A more detailed component or module view of the system is shown in FIG. 5. An input interface module 501 receives data from customer data sources 503, as well as bulk queries 505. An example of a query 507 entered using a graphical user interface (GUI) is shown in the form of “Who landed on the moon?”.

The input interface module communicates the input data (queries or customer data) to the text processing module 511 where the module carries out its functions as herein described. The text processing module is in communication with the parsing and semantic module 513, which carries out its parsing, syntactic and semantic functions as herein described. The parsing and semantic module utilises and is in communication with a training set of data 515 for training purposes or a lexicon once training has been completed, as well as clauses from a customer data store 517 and data from a semantics database 519.

The training set is used initially for creating HMM and probabilities to form the lexicon.

The output of the parsing and logic module 513 is communicated to the inference engine or module 521, where its associated functions are carried out as herein described. The inference engine is also in communication with the semantics database 519 and the stored clauses from the customer data store 517, as well as a store of consensus knowledge 523. The inference engine output is communicated via the output interface 524 in the form of a bulk response 525 or a single (or group of) answer(s). For example, the output may be provided as an answer 527 on the GUI interface in the form of “Who: Neil Armstrong”.

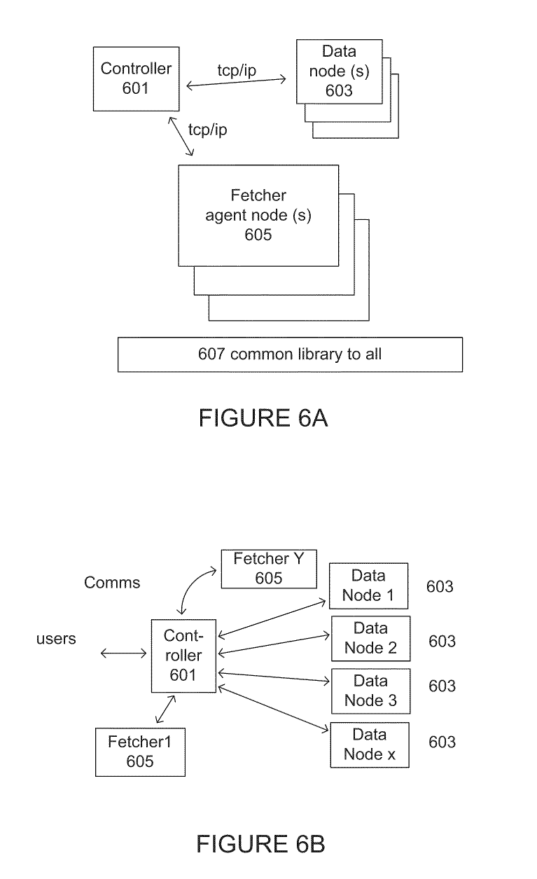

The following provides details on the architectural structure of the system. A high-level logical view of the software components involved is shown in FIG. 6A.

At this level the system consists of three main components or modules; Controller Node 601, Data Node(s) 603, Fetcher Node 605. These components are preferably kept isolated for two reasons, (a) the components have different roles and functionality that separates them, (b) this separation facilitates scalability.

The Fetcher node may have many instances and be run on remote systems.

The System also has a main library 607 that is shared between all components. This library can be viewed as a base library of services required by all components (e.g. TCP/IP communications handling, object serialisation, Xml parser, etc.). It is possible that each of the main components is deployed on different servers. All components communicate using Inter Process Communication (IPC) using TCP/IP. The Data node can have any number of instances, as can the Fetcher node.

The Controller node is the external/client facing component that balances load and fetches data.

The Data node is the central processing node. A single installation can consist of many data nodes. Each data node communicates with a controller node to solve queries.

The Fetcher nodes are responsible for searching external resources and retrieving information from them. This information is then transformed by the Fetcher node to a specially annotated text type format that is parse-able by the parser. The annotated text format includes special markers for document headings and document tables to facilitate their interpretation by the parser. Fetcher nodes can run as independent agents on remote systems.

Referring to FIG. 6B, a diagram indicating the communication channels between components of the system is shown.

Users communicate with the controller node 601. The controller node 601 is in bi-directional communication with each of the fetcher nodes 605 (1 . . . Y) and data nodes 603 (1, 2, 3 . . . x).

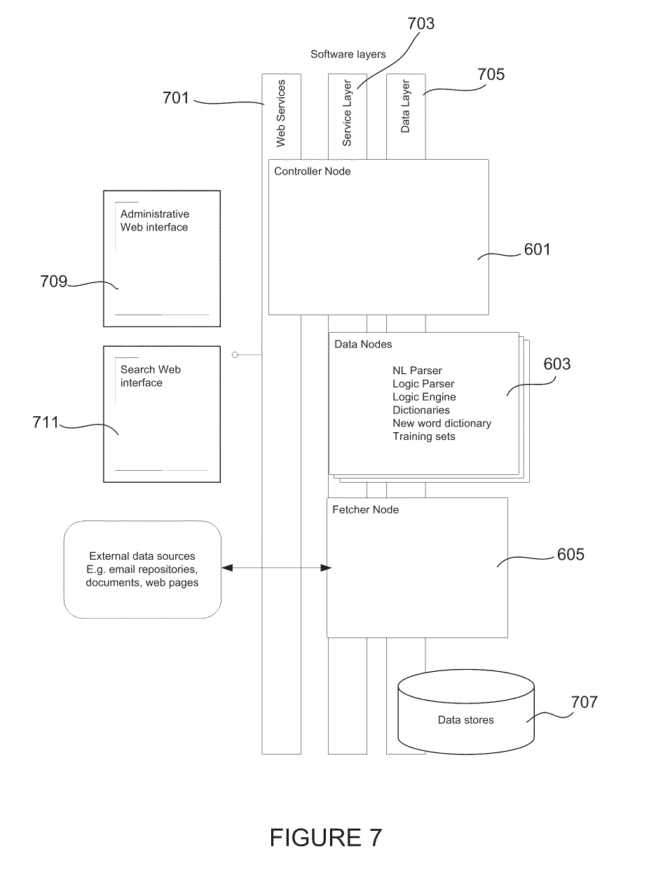

FIG. 7 provides a detailed breakdown of the structure of the system.

The various software layers are indicated as the web service software layer 701, the service software layer 703 and the data software layer 705. The controller node 601 overlies all three software layers. The data nodes 603 and fetcher node 605 overlie the service and data software layers. The data software layer 705 is also in communication with the data stores 707. The web services software layer is in communication with various interfaces, including an administrative web interface 709 and search web interface 711. As explained above, the fetcher node 605 is in communication with external data sources, such as e-mail repositories, documents and web pages, for example.

The above described system is used to determine one or more unambiguous logical representations using a semantic dictionary and verb rules. Further, by relating each verb to a limited sub-set of verb definitions, relevant text structures in the source data may be detected. The system applies the process to text detected in source data as well as to queries provided as an input to the system.

The marked up semantic representations are used to link a query with one or more portions of text within the source data. Portions of text within the source data may also be linked to other portions of text in the source data, or in data from other sources, where those portions of text have been determined to be of a similar or matching grammatical nature, i.e. the information that the portions of text convey is the same or similar.

The system works based on the premise that verbs drive actions within language constructs. As such, by linking verbs together to form a limited sub-set of verbs for various basic actions, a fast and accurate search becomes possible. The potential losses through the use of a limited sub-set of verbs is mitigated by the syntactic and semantic analysis of the data input and the calculations of probability values for the association between the data inputs, whether this is an association between a question and a data source, or between two different data sources, or any other form of calculable association.

Therefore, the system determines the verb in the sentence string and attaches other parameters to that verb to create a logical representation of the sentence string, and a frame that identifies the sentence structure. The logical representation is then expanded by mapping the verb found in the sentence string to a limited sub-set through the linkages of that verb in the lexicon to other related verbs. This grouping or linking of related verbs can then be used to associate the verb in the sentence string with other similar alternative verb uses for the action associated with the verb, and as such enable grammatically similar sentence strings to be found. By enabling the system to expand the logical representation in this way, different complex sentence structures may be associated with other sentence structures.

Further, extra parameters may be added such as location and time, as well as “auxiliary” actions such as including further objects and subjects that are affected by the verb. Additionally, adjectives and adverbs may be included in the representation where applicable, and may be tied or linked to the subject, object or verb as appropriate.

Therefore the system may be utilised to perform a natural language processing method using any suitable computer platform. The processing steps include analysis modules (text processing modules and/or parsing/semantic modules) arranged or adapted to analyse a sentence string within textual information in order to determine sub-components of the sentence string. A sub-component may be considered to be a single part of speech, such as for example, a single word or a group of words considered to be a single part of speech, for example, noun phrases and verb phrases.

In order to determine the sub-components within the textual information the text processing module of the system may process and analyse the textual information in order to detect anaphora and conjunctions.

The textual information may be provided via the input interface to the system directly in its textual form, or alternatively may be provided as a document file, or a reference to a document that is stored in any suitable storage medium. The textual information may be retrieved from the document by retrieving the document, and analysing the document using the analysis modules to detect the textual information within the document.

As an alternative, the manner in which the textual information is received by the system may vary and may be of any suitable form. For example, the data may be transmitted to the system using any form of transmission, such as wired or wireless. Any suitable transmitting and receiving technology may be utilised such as UMTS, 3G, 4G, infra red, Bluetooth, TCP/IP, etc. Further, the data may be transmitted and received using any suitable data transfer technology such as data stream technologies, peer to peer technologies, server technologies, natural language speech reception and transmission technologies (e.g. spoken languages) etc.

The retrieved data may include a number of tags identifying elements that form the document, such as tags that are used to identify headers, footers, titles, paragraphs, headings, tables etc. These tags may take any suitable form that is detectable, such as html, xhtml etc. By using and detecting these tags the system can detect passages of textual information. Further, punctuation symbols within the document may be detected by the system in order to determine and detect the start and end of sentence structures or strings. For example, capital letters, commas, full stops, question marks, colons, semi-colons, quote marks, or indeed any other form of punctuation or language symbol may be detected.

Therefore, it is envisaged that any form of data may be analysed in order to determine the start and end of sentence strings within textual information.

The data retrieval process and modules may take any suitable form. In this embodiment, a document is retrieved from a customer's data store using a suitable document retrieval interface (input interface) and a communication protocol. However it will be understood that, as an alternative a document retrieval interface may be used that is in the form of a document server, a scanning device, an e-mail interface, or a peer to peer interface, or indeed any combination thereof, and that the appropriate methodology of retrieval will be adapted according to the technology used.

Once the sub-components of the sentence string have been detected, one or more unique tokens are assigned to each of the determined sub-components by the parsing/logic module. Each word that is unique has a unique token. What makes a word unique is the combination of the text (i.e. the word itself), its part of speech (i.e. the syntax (e.g. verb, noun, etc)) and its semantic.

The system determines the syntactic use of the sub-component and applies a unique token based on the determined syntactic use. The syntactic use determination therefore determines whether the word is being used as a noun, verb, adjective, pronoun, etc. including any other syntactic form.

A set of pre-stored records, i.e. the lexicon (semantics database), including every known available word is available to the system. That record includes a unique token identification for each instance of each word known to the system.

Therefore, the system can search for the word (sub-component) in the records, and once the record is found the associated unique token is assigned to the sub-component.

The lexicon includes a set of pre-stored records for potential sub-components (e.g. words). These records include a list of all known relevant synonyms, semantic markers, semantic verbs and lexical relationships that are associated with the word to which the record relates. The lexical relationships may also include a list of synonyms, hypernyms, meronyms, antonyms, holonyms, hyponyms and instances of each word to which the record relates.

Each word may have multiple meanings, even if spelt the same. For example, the word “bank” may have several different meanings depending on the context in which it is used. For example, it may be a noun or a verb, i.e. a syntactic difference. It may also be one of several different nouns or verbs, such as a bank (noun) that is a financial institution, and a bank (noun) that is the side of a river, i.e. a semantic difference. Each meaning has a unique token assigned to it. As new meanings arise due to a change in language usage, new tokens may be assigned to the new meanings. For example, the use of the word “text” may now be used as a verb in relation to sending SMS messages using mobile devices.

A further step carried out by the system is the determination of a probability-of-use value for specific meanings, whether semantic or syntactic, of the sub-component. This step is clearly only required if the sub component has multiple potential meanings, and therefore, if the system determines that the word is clearly unambiguous, this step may be bypassed.

One method of determining a probability of use involves the system determining the semantic use of the sub-component For example, the determination of the semantic use of a sub-component may be required where the sub-component is a noun. Based on the context in which the noun is used, the probability that the noun is being used to define a certain concept or thing is determined. For example, what is the probability that the word “bank” is being used to describe a financial institution as opposed to the side of a river?

The system determines the probability of semantic use of the word that is being analysed (the determined sub-component) by analysing further sub-components (i.e. words and simple sentences) that surround or are nearby to the word being analysed.

This semantic probability of use calculations are used for semantic analysis only and are separate from the syntactic probabilities. Syntactic probabilities as discussed above are calculated through separate syntactic training sets that create a syntactic Hidden Markov Model.

Upon detection of these nearby words, the system analyses the lexicon to see if the lexicon can identify that those nearby words relate to, or are associated with, the word being analysed. For example, the detection of the word “money” nearby would indicate that the word “bank” has an intended use of a financial institution, and a probability value would be accorded to this specific meaning. Alternatively, the detection of the nearby word “fish” may indicate that the word “bank” is intended to mean a river bank, as fish swim in rivers. However, the word fish may also still be associated with a financial institution, as the term “phishing” may be used in this context. As the word “fish” is a misspelling of the word “phish”, the probability of use value associated with this context would be adjusted accordingly and so the more likely probability of use would be that of a river bank.

Further, the system can adjust the probability of semantic use value for the sub-component by determining and analysing further sentence strings within the textual information in order to find further sentence strings that are relevant to the sentence string. The probability of use value may then be adjusted based on the distance between the newly found sentence string and its meaning and the sentence string being analysed.

Also, the system may adjust the probability of semantic use value for the sub-component by determining the likely subject matter of a document in which the sentence strings are located. This may be carried out by statistically calculating the re-occurrence of certain words, the detection of a title or heading, the detection of an abstract and further analysis of the abstract to find relevant words or any other suitable method to narrow down the intended meaning of the sub-component.

Also, the system may adjust the probability of semantic use value for the sub-component by retrieving a pre-determined probability of use based on an analysed training set of data. That is, based on known uses of particular words, it is possible to pre-determine the likelihood that the detected word is being used in a certain context, and therefore has a pre-determined semantic use.

Thus, based on the determined probability of use values that have been calculated by the system, a valid set of unique tokens are created, which are associated with the sentence string being analysed.

As discussed above, the system links the detected and determined verb sub-components (as identified by their unique token identifications) of the sentence string to a pre-defined limited sub-set of verbs through the lexicon. A frame in the form of an identification tuple is created for the detected verb, along with its associated arguments. The frame may be stored using any suitable storage medium, or used without storing.

Therefore, in this embodiment, the semantic algorithm of the system operates using the following successive steps:

Step 1: The system uses the set of relationships stored for each version of the sub-component to determine if surrounding words in the same sentence provide any indication of the usage of the noun.

For example, the definition (i.e. lexicon entry) for bank, i.e. the money institution, contains:
Synonyms: financial institution, fund, investment, firm, etc.
Semantic markers: money, transaction (these are special associations that are introduced to detect such relationships).
Semantic verbs: to put (into), to bank, to pay (these are verbs that can be related specifically for this sense of the noun). Therefore, each lexicon verb entry is associated with, or has a link to, a predefined sub-set or group of verbs that relate to the same meaning. In this example, the verb “bank” in the text string, has a unique entry in the lexicon, and a unique token ID associated with it. The entry includes a pre-defined sub-set of verbs, such as “to put”, “to bank”, “to pay”, which all relate to paying money into a financial institution.
The standard lexical relationships such as synonyms, hypernyms (part of relationships), meronyms (part of relationships), antonyms, and instances (e.g. the Bank of America, BNZ, ANZ, etc).

Step 2: If step 1 does not provide a satisfactory result based on determined threshold limits, the system widens the search to other sentences before and after this sentence using the same search. Therefore, the further away from the sentence being analysed, the less likely the other sentence is relevant and so the scores are adjusted accordingly.

Step 3: If step 2 does not provide a satisfactory result, the system determines the, or uses an existing, “tone” of the document. The “tone” is a summary of the general content or subject matter of the document based on the concepts discussed in the document. For example, if the system does not specifically find references in the document such as “GDP” and “economies of scale”, it can still infer that the term “bank” is referring to a financial institution through the links of these concepts, as defined in the lexicon. That is, the system looks at “GDP” and “economies of scale” in the lexicon and uses their listed relationships to see if there is any overlap with the relationships within the “bank” entry in the lexicon.

Step 4: If step 3 does not provide a satisfactory result, as a further analysis, the system uses the following method. A set of probabilities from previous training sets are stored for each noun. A lot of nouns have rare and common uses. The system calculates the probabilities of a noun being one sense over another through usages in specially crafted semantic training sets which were created through using the same algorithm described here. These are crafted from the original syntactic training sets. This set provides the system with a number, for example, bank: financial institution: used 80% of the time, bank: side of a river, used 20% of the time.

Further, the system inserts a reference within the identification tuple to the sentence string to which it relates by referring to the document, its storage media, relevant page, paragraph, sentence etc. That is, the reference is sufficient to be able to identify the relevant sentence string from the data store from which it was obtained. If the identification tuple is associated with one or more sentence strings, then a separate reference is inserted in the identification tuple to identify the relevant portion of the document in which the each sentence string is located.

A link is therefore created that typically relates a document to a frame (identification tuple). In this case the data structure for the frame may contain a field called “sentenceId” that is a reference back to a sentence (in the document) that generated the frame. Since many documents can create the same frames, because they talk about the same information, a situation can occur where the same frame is generated by multiple sentences of one document as well as similar sentences of other documents. In this case the system identifies this and creates a “many to many relationship” between the two, which in effect gives the one frame two sentence references (which in turn reference the documents).

Therefore, a document is stored that consists of a list of sentences. Each sentence is stored as a separate data structure referring to its parent document. Each sentence can consist of one or more frames. That is, each frame relates to a sentence in a document. By working back from a frame to a sentence, and a sentence to document, it is possible to identify the original document(s).

A set of rules have been developed that identify the common usage of certain words. The system (inference engine or module) may access these rules and apply them to the frame (identification tuple) in order to take into account how the words are used in everyday standard usage of the associated language. The rules may, for example, relate to certain colloquialisms, identify shortened versions of words when used in speech text, provide common sense knowledge, or provide a common consensus on the usage of particular words or certain jargon that is used.

For example, the word ATM may mean different things to Engineers than from people in the street. So either (a) the surrounding context of the usage of the word (as previously discussed in the algorithm)—or the semantic probability for a word (either defined in the global lexicon or defined in a Jargon specific lexicon) will overwrite which meaning the system is to use. Therefore, the system may be implemented in a specific way depending on the technologies the user is based. For example, if the system is implemented for an engineering firm the lexicon will be adapted to indicate that the more likely use of ATM is the electronics use (Asynchronous Transfer Mode) and not as an Automated Teller Machine.

It will be understood that the rules may be adapted over time either manually by the user, operator or administrator of the system, or alternatively, the rules may be modified automatically based on the detected probability of use values that have been determined for the word. That is, the system can be taught.

For example, for the sentence “by the bank”, the system has analysed the sentence and has calculated probabilities that it is 99% sure the noun “bank” is a financial institution and 1% sure that it is a side of a river.

The user of the system then corrects or teaches the system that the word “bank” relates to a side of a river and not a financial institution.

Therefore, the system uses the rest of the sentence and/or document as evidence for this semantic change based on the rules given before, and then adjusts and checks all existing instances of the word “bank” in all documents against the new evidence. This ensures that the system continually updates its rules based on real world examples in order to provide more accurate results.

In this way, relationships between the word being analysed and other words may be inferred based on the rules and consensus data.

One detailed example of this is the use of common sense knowledge, which is usually omitted in every day conversations. For example, in the following passage containing two sentences “John had a box of matches. John lit the candle.” It is known who did what (John lit the candle), and it is known what John had (John had matches), but the system is unable to answer the question “How was the candle lit?” as the information “matches can light candles” is missing from the passage. By having a rule that states “matches can light (or set fire to) objects”, this provides the required “common sense” information to the system.

As mentioned above, the system has incorporated therein an error management module that determines or detects “invalid” sentence strings, i.e. sentence strings that can not be processed by the system so that a set of unique tokens can be mapped to the sentence within a predefined probability of use value(s). In a scenario when such sentence strings cannot be parsed correctly, the system identifies the sentence string (by way of a reference) and flags the sentence string as not having been validly processed. A log of this is created so that a user or administrator of the system may, via a user interface, review any created logs and manually fix where appropriate the entries. Also, a user of the system may review any new concepts that have been found in documents, such as new words that have not yet been entered in the system lexicon, and manually categorise the words or concepts by identifying or specifying which syntactic part of speech the word/concept belongs to, the semantic relationships and other relationships with existing words.

For example, a sentence string may be logged and displayed for correction by a user or administrator. The corrector may then assigned a new unique token to the unrecognised word, and create a list of suggested synonyms, antonyms etc for the word. The sentence may then be allotted a correct sequence of unique tokens (including the newly created token) either by the user manually or by the system after it parses the sentence string again.

As briefly mentioned above, the system may also include special modules to perform functions, such as a statistical determination module to perform count functions. In this way statistical information may be determined when analysing portions of text, whether this is a single sentence string, a paragraph, a whole document or a set of documents.

For example, the statistical determination module may apply special functions in order to determine quantity information within the sentence, paragraph, document, set of documents etc. One such example is a “count” function that may return the number of occurrences of a particular word or concept. If the original information presented to the system included “The red room contained 3 cups. The green room contained 5 cups.” Then the system may be asked “How many cups where there in the rooms?”. The system would detect in the question that a quantity is being requested based on the “How many” portion of the question, and so the system would initiate the statistical determination module in order to activate a “count” function within the module. The count function may then analyse and statistically determine how many cups are in the room based on the statements made and their determined meaning, and output a statistically based result.

It will be understood that various other statistical functions may be included such as calculating the mean and average. Further, functions may be introduced in general to solve particular problems as needed for a particular domain.

In this embodiment, the system is set up to answer search queries that are entered or supplied to the system via the user interface.

The analysis of a search query is carried out in a similar way to the analysis of sentence structures within documents, as described above.

That is, the query is analysed to determine sentence structures and sub-components (words and simple sentences) in order to determine one or more valid frames that are associated with the query. These frames are used to identify relevant sentence structures in the document database. The analysis of the query in this way extends or enhances the search query by including synonyms, hypernyms, meronyms, holonyms, hyponyms etc where applicable.

Therefore, all relevant alternatives for sub-components within the search query are used to find the relevant sentence structures. Each alternative has an associated probability of use value associated with it so that the relevance of a particular sentence structure can be determined. By extending the search query in this manner, the chances of finding the most relevant answers in the document database is increased significantly.

Once the one or more relevant frames have been determined for the search query, a search is then carried out in the database to identify the relevant parts (i.e. sentences, passages, tables etc) in the documents that are associated with the same frames. The following describes the pattern matching process and rules that the system uses to match queries with text portions of search media.

As a first step, the system performs a probability calculation based on how closely the verb of the question in the question frame matches with the verb used in associated stored frames. The closer the match, the higher the probabilities score for that match. For example, the system uses a set of “verb synonyms” based on the linkages created in the lexicon entries for the verbs, i.e. the pre-defined limited sub-set of verbs. Further, the system has verb conjugation and past tense information available. Therefore, using the example of matching the word “stroll” with text passages, the system will map “stroll” onto the generalised verb “walk”. Further, the system will know that “walk” and “stroll” are linked to “walked” and “strolled”. Each of these occurrences in the search data will provide a different matching value based on how close the text matches the question. Therefore, the matching score is affected (e.g. “walked” and “walk” do match, but because of the different tense there is a mark-down, and the same applies to matching “walk” with “stroll”).

Further, the system adjusts the matching score based on matching parameters or arguments of the verb in the question frame and prospective answer frames. In order for an answer to be valid, there must be at least one common parameter or argument. That is, each of the parameters or arguments of the verb in the frame must have at least one item in common and the matching value of the frames is marked down or up depending on the number of items they have in common, and how closely the items relate. For example, an exact word match will be given a higher match value than a synonym match of that word. This applies for all linguistic concepts (synonyms, meronyms, hypernyms etc) and so, the closer in linguistic terms the parameters are, the higher the matching score the system allocates.

Also, the system determines what the piece of missing information is based on the question being asked. That is, the system is aware at all times that questions by definition have a missing piece of information that is to be discovered. For example, “Who walked in the park?” is a question asking about a person walking in the park. The system therefore is required to match this question with a frame such as “John walked in the park.” where “Who” then becomes associated with “John” since their semantics match. “Who” by definition refers to a “person” semantic and “John” by definition is the name of a “person” (or more accurately “John” is a proper-noun (part of speech) representing a person (it's semantic)).

Therefore, the sentence strings form at least part of a natural language search query, and one or more frames (identification tuples) created from the query by the system are matched against one or more existing frames (identification tuples) that have previously been analysed in order to find answers to the query.

To get an ideal answer, the system will attempt to find an exact match wherever possible, where the verbs and other components of the question frame (their unique tokens) directly match with the components of the answer frame (their unique tokens). Also, the system utilises the linked limited sub-set of verbs to expand or enhance the search query. Therefore, a match is sought wherein a verb in the target frame matches with the verb in the query frame; the closer the similarity to those verbs (in the query and target frames), the closer the matching score given. This in effect provides a rank value based on related synonyms and the tense of the actual verbs used in the query and target frames.

The following provides a simple example of how the system analyses a simple sentence structure, such as “John put his money in the bank”.

The unique tokens allocated to the sentence are as follows:

John=Token1

put=Token2

his=Token3

money=Token4

in=Token5

the=Token6

bank=Token7

The system parser determines that:

John=Token1, proper noun

put=Token2, verb

his=Token3, pronoun

money=Token4, noun

in=Token5, preposition

the=Token6, determiner

bank=Token7, noun OR=Token 8, verb

For simplicity's sake in this example, we shall assume that only ‘bank” is semantically ambiguous, and so the definitions are as follows:

John=Token1, proper noun, semantic: person

put=Token2, verb

his=Token3, pronoun, resolved to “John's” by anaphoric reference resolver

money=Token4, noun, semantic: possession

in=Token5, preposition

the=Token6, determiner

bank=Token7, noun, semantic: man made (financial institution definition) OR natural (side of the river definition)

Therefore, the system is required to resolve whether Token 7 or Token 8 is applicable, as well as the semantics of Token 7 or Token 8.

To do this, the semantic algorithm above is used and the following results are obtained.

John=Token1, proper noun, semantic: person

put=Token2, verb

his=Token3, pronoun, resolved to “John's” by anaphoric reference resolver

money=Token4, noun, semantic: possession

in=Token5, preposition

the=Token6, determiner

bank=Token7, noun, semantic: man made (financial institution defn.)

The system therefore creates a frame (identification tuple) as follows:

FRAME=put: John (person), money (possession), in the bank (man made, financial institution)

The tuple takes the following form: T2 T1 T4 T7

(Note: the verb goes first, words like prepositions, and determiners are not explicitly put in the frame, they actually belong to Token 7 in this example which really expands to “in the bank”). The pronoun “his” in this instance is not used since it refers to “John” which is already used with put.

The frame T2 T1 T4 T8 is discarded as the semantic algorithm will determine that the word “bank” is not being used as a verb in the sentence based on the preceding word “the”.

Using the pattern matching process previously described, a list of ranked “answer” frames based on the pattern matching process is provided. References to the sentences associated with these ranked “answer” frames may be retrieved using the database.

For example, the following questions may be answered:

“Who put money in the bank?”

“Where did John put his money?”

“What did John do?”

Furthermore, since the system has determined that a financial institution was involved in these examples, it can highlight further information in all other documents regarding (a) John, (b) money, and (c) banks.

The embodiment described thus provides the tools required to analyse a submitted natural language question and return a limited set of answers with good accuracy over a set of encyclopaedic knowledge. Further, the system provides the ability to ask precise questions and obtain a highly relevant response (with fewer iterations of search).

### Second Embodiment

The herein described embodiment is aimed at automated classification of documents. The documents may be, for example, electronic files (e.g. scanned files or files created using software), web pages (in any suitable format), email messages (in any suitable format), and other textual content. The automated classification enables faceted search or navigation of content according to specific topics. The topics may include, for example, people, places, events, timeframes, and other subjects as defined by the user of the service. The automated classification also enables automated storage, disposition or dissemination of documents based on a set of rules, where the rules use the classification of the documents to determine how the documents are handled.

The system herein described forms part of a Metadata Discovery and Extraction system. It will be understood that the system herein described may also form part of other suitable alternative systems, such as, for example, an automated classification system, an automated document storage facility, an electronic document storage and classification system, an electronic document analysis system, an electronic document search system etc.

The types of input sources (including documents) that may be processed by the first embodiment also extend to this embodiment. For example, the input sources and/or documents may be word processing documents (such as Microsoft Word, for example), PDFs, HTML, XML, and Databases.

The various methods and system described above in the first embodiment are utilised in this embodiment in order to discover metadata within the documents being processed. That is, the system described in the first embodiment is used to determine one or more unambiguous logical representations using a semantic dictionary and verb rules. As in the first embodiment, each verb is related to a limited sub-set of verb definitions, to enable relevant text structures in the source data to be detected. The system applies the process to text detected in the source data.

Portions of text within the source data may also be linked to other portions of text in the source data, or in data from other sources, where those portions of text have been determined to be of a similar or matching grammatical nature, i.e. the information that the portions of text convey is the same or similar.

By using these core methods, a source is processed by the herein described system to determine metadata within the source as follows.

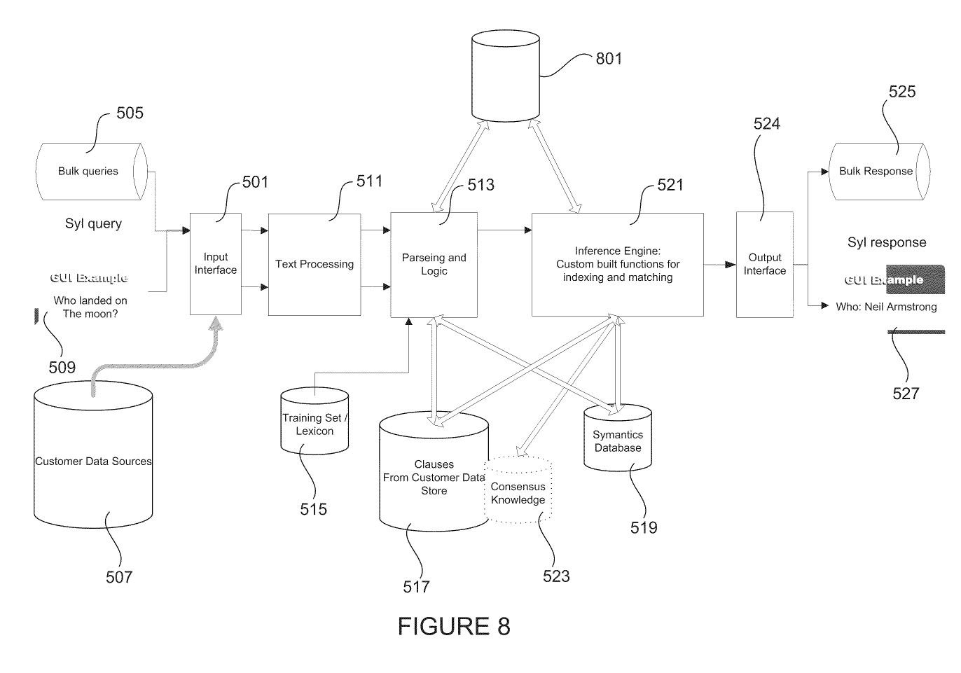

FIG. 8 shows a system block diagram including a metadata library module 801 for use in this embodiment. The metadata library module is in communication with the user interface of the system to enable users to enter and/or select various user defined metadata. All other components and modules in the system of this embodiment are the same as described in the first embodiment

The input interface module communicates the input data to the text processing module where the module processes the text to identify sentence structures, as in the first embodiment. These sentence structures are parsed by the parsing and logic module based on pre-defined default metadata, user defined metadata and data from a semantics database.

The output of the parsing and logic module is communicated to the inference engine or module, where inferences are made based on a set of rules as described above in the first embodiment. That is, the inference engine is in communication with the semantics database, a pre-defined default metadata library 801, a user defined metadata library 801, as well as a store of consensus knowledge. The inference engine output is communicated via the output interface.

It will be understood that an alternative to combining the predefined default metadata library and user defined metadata library would be to use two individual library storage facilities for each of the predefined and user defined metadata.

According to this embodiment, the output is in the form of a set of classification data associated with the source. The classification data may be associated with a particular portion of the source or the source as a whole.

For example, the analysis of a single document using the above described method may result in various sections of the document being associated with particular metadata types as defined herein. Therefore, the document may then be classified according to these found metadata types. For example, the document may be automatically stored in one or more database associated with the determined metadata type(s). Alternatively, the document may be tagged with the detected metadata type(s) so that search engines can identify the document based on searches that match the determined metadata type(s).

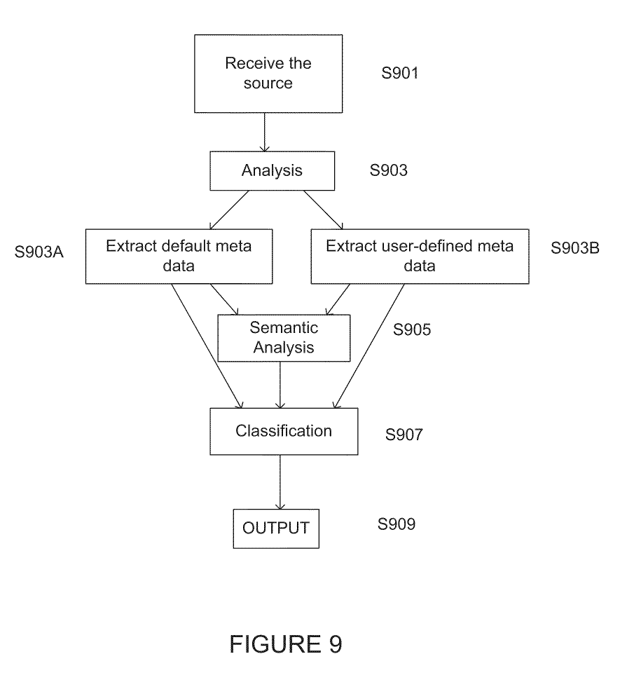

Therefore, as shown in FIG. 9, the system retrieves or receives the source (such as an electronic document) at step 901. The document is then analysed at step 903. At step 903A metadata associated with the default metadata types stored in the metadata library are extracted. At step 903B metadata associated with the user defined metadata stored in the metadata library is extracted from the document. At step 905, semantically analysis is carried out to determine-the context of the extracted passages and to define a unique unambiguous representation of the relevant passage in the document, according to the methods described in the first embodiment. At step 907, based on the determined metadata and its determined context, the document is classified according to one or more classifications, and the classification information is output at step S909.

As in the above embodiment, the classification data is stored in the form of identification tuples to identify the relevant sentences or portions of the source and associate it with the identified metadata and its context.

The classification(s) assigned to the document may then be used to store, classify, compartmentalise, transfer, search or navigate the document, as well as or instead of performing any other suitable action that relies on classification.

Various default types of metadata are defined for extraction and may include people, places, events, timeframes, email addresses, monetary values, or any other suitable topics of interest. Further, the user of the service may also specify particular topics of interest as the user-defined metadata, where these definitions may be specific to the user's area of expertise, work or industry. Concepts that are semantically associated with the topic of interest will be matched as relevant during the semantic analysis.

The probabilities assigned by the system to matching entities or topics in documents are returned with the associated metadata values. Probabilities are assigned using the same method as the first embodiment, i.e. that the entity or topic is the correct “part of speech”. For example, that the word detected is being used as a noun, verb, etc., and has the correct semantic meaning as intended by the user (i.e. as defined by the user's metadata).

This classification information may then be used by rule-based systems in determining the document's disposition, or to communicate a level of confidence of the accuracy of the metadata value match.

As in the first embodiment, the semantic probability-of-use calculations may make use of nearby words and sentences. For example, the detection of the word “money” nearby would indicate that the word “bank” has an intended use of a financial institution.

As in the first embodiment, the system may make use of user supplied lexicons and semantic associations that accommodate the user's own jargon and meanings, or make use of system configurations designed for specific industries, such as legal, health, etc.

The system can be trained using a method of feedback or additional training sets to refine the probability calculations for a specific environment or use.

Special functions may also be applied in determining some metadata values, such as aggregation of monetary amounts, or classification within a timeframe, such as a year, decade, or other period.

Documents may be submitted via a programmatic interface and return results in either a human-readable or machine-readable format.

### Third Embodiment

This third embodiment is directed toward tracking subject matter, such as entities or topics defined by a user. This subject matter may include, for example, people, companies, brands, trademarks, and other subjects, that may be mentioned or discussed in various electronic media, including web discussion forums, blogs, twitter feeds, and other social media.

In this embodiment, the system is an information gathering and reporting system which may be used alongside or in conjunction with various tracking applications that harvest information from various forms of social media.

For example, brands are now commonly discussed using multiple forms of social media, such as Twitter for example. These discussions may play a large role in shaping and propagating customer opinions and buying patterns associated with the brand. The characteristics of these new types of social media are that the resultant communications can be more open and honest (i.e. less controlled by the brand owner), and more timely.

The various types of input sources and documents that may be processed using the systems and methods described in the first embodiment also extend to this embodiment. The types of input sources and documents typically include HTML, RSS, Atom Feeds, Twitter, and other web formats.

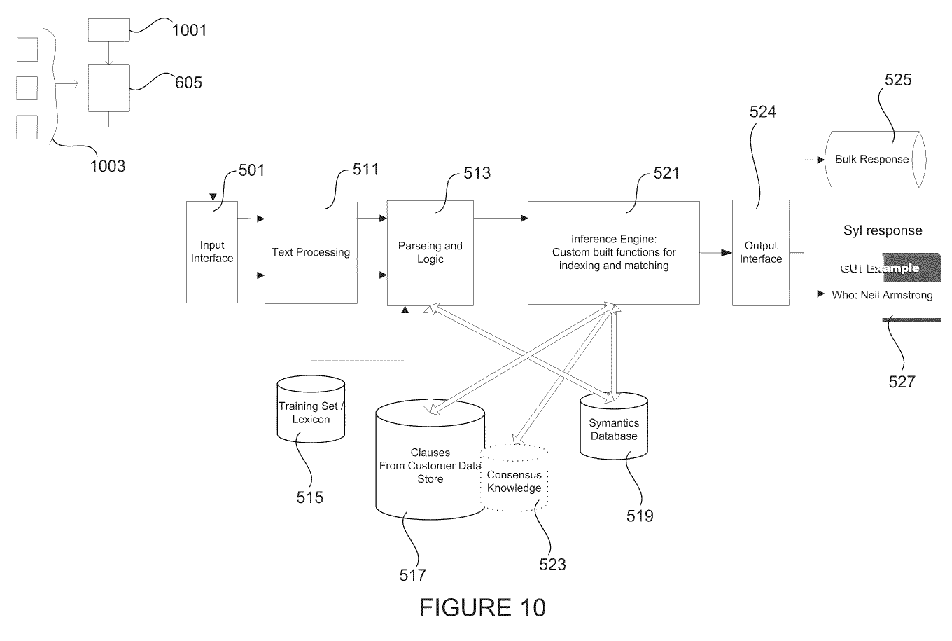

The same system as defined in the first embodiment is also used in this embodiment to perform the analysis of the textual data. According to this embodiment, and referring to FIG. 10, the fetcher node 605 retrieves instructions 1001 and retrieves textual data from one or more identified sources 1003 for input to the input interface 501.

Input sources 1003 are processed using the Fetcher node 605 as shown in FIG. 6. That is, the Fetcher node follows suitable links from starting locations, such as a web address, as configured by the user or as set as a default and stored in a default starting location library 1001. That is, the user selects one or more sources of information that they want to be tracked, and provides the fetcher node with the suitable URL, user name, password or any other identification information that is required to access the information. The fetcher node then provides the data from the starting location or source as an input to the input interface 501.

Therefore, referring to FIG. 5, the input interface receives a stream of textual information, continuous or intermittent, from the selected web address or other textual source as defined by the user.

The same methods as described in the first embodiment are then performed on the incoming data to contextualise the data.

That is, the system and method described in the first embodiment is used to identify document instances where a configured entity or topic is mentioned. The entity or topic may be defined in the customer data source 507 as shown in FIG. 5 or may be provided as a separate bulk query 505. The topic or entity may be any suitable topic or entity that the user wishes to track, such as, for example, their brands, company name, competitors etc. For any matching data, an identification tuple is created as explained in the first embodiment.

Furthermore, the incoming text is analysed to determine the context of statements made about the entity or topic, such as whether a value statement made about the entity or topic is classified as positive, negative, or neutral.

Special functions may be applied to aggregate measures such as the number of positive statements made overall for the entity or topic, the trend in the number of mentions made over time, or the time since the last mention.

### Further Embodiments

It will be understood that the embodiments of the present invention described herein are by way of example only, and that various changes and modifications may be made without departing from the scope of invention.

For example, it will be understood that the linking of verbs in the lexicon may be replaced by, or supplemented with, separately categorising each verb within a predefined sub-set of verbs, and associating each verb with the predefined sub-set. For example, a frame may include a reference to a predefined sub-set of verbs, such as a “communication process verb group”, which is stored in the system database. Within the group of communication process verbs, all related and associated verbs may be listed or at least identified by reference. Also, references to the group may be inserted in the lexicon entry for each verb.

Further, it will be understood that it is not necessary to permanently store frames for use by the system at a later time. That is, the system may determine the contents of frames as and when they are required. For example, upon receiving a query the system may analyse the query to determine the unambiguous representation of that query, and as such will determine at least one verb associated with the query. That verb is looked up in the Lexicon and the verb synonyms linked to, or associated with, that verb are determined by the system. The system may then parse the data stores to find relevant text passages that contain a verb that is linked to or identical with the verb in the unambiguous representation. This dynamic searching technique may be particularly advantageous in systems where the data store is continuously being changed or updated.

Further, it will be understood that the various modules and processes herein described may be realised using any suitable technology. For example, the functions of the modules and processes may be performed using software, firmware, hardware or any combination thereof. For example, certain modules, such as the input interface module, may be formed from a standalone hardware appliance, whereas, various analysis and text processing modules may be embedded within a specifically adapted computing device in communication with the data retrieval module. Alternatively, as a further example, the various analysis and text processing modules may be formed from standalone hardware appliances adapted to receive the incoming data, where the analysis output is then forwarded to a specifically adapted computing device for dissemination of the analysis information.

Further, it will be understood that the various methods described herein may be implemented using an Internet-addressable programmatic interface (e.g. a web service accessible via a URL). For example, the web service may be accessed by users through the provision of an identifiable user name and password.

Further, it will be understood that where the various functions of the described system are utilised using software that any suitable programming language may be used to create the software to perform the various functions described. The software program may be implemented using any suitable hardware. For example, any software program may be stored on any suitable computer readable device, such as a ROM, RAM, hard disk drive, flash memory or the like. The software program may be read and implemented by any suitable computer processing device in order to perform the functions described.

Further, it will be understood that the modules or processes may be utilised using separate modules and processes for each function, or alternatively may be utilised by combining separate modules and processes together to perform the individual functions.

Although the herein described embodiment specifically describes a system that is used as a search tool, it is envisaged that the methodologies described may be implemented in other natural language processing areas and technologies.

It will be understood that the system as described may be customized, configured or adapted for multiple applications along the three dimensions of assigning equivalence, making inference and applying special functions. The system may be adapted to support a variety of application, business and user needs, and may be adapted to become progressively ‘smarter’ in ways which are relevant to current or future requirements.

Further the interface mechanisms may be adaptable to permit connectivity to a range of data sources and systems, for example, an interface via a web-service may be utilized to provide a web-service/xml interface for submission of queries and return of results. Alternatively, for example, database API may be utilized to ensure that the system can be integrated to connecting systems and interfaces through a defined and documented protocol.

The system may be configured to connect to a range of user systems for a range of uses. For example, modular implementation of filters may allow for an expansion of the different type of data stores and data formats that can be accessed, while a web service interface may assist in connecting the system to a wide variety of applications. Further, the system design supports incremental enhancement of the semantic equivalence, inference, and special functions of the various modules and expansion of the volume of data and data types which can be processed. Therefore, the system as described has the capacity to grow and to encompass the volume and type of information within an organisation as the organization expands. Some aspects of this growth are configurable by the end users' organisation, as well as being configurable by adapting the internal workings of the system.

Finally, it will be understood that specific elements or steps in one embodiment of the invention as described herein may be combined or used as an alternative to other elements or steps in alternative embodiments, where appropriate.

1. A computer implemented natural language processing method, the method including the steps of:
analysing a sentence string within textual information to determine sub-components of the sentence string,
assigning one or more unique tokens to each determined sub-component,
determining a probability of use that a determined sub-component has one or more specific meanings,
based on the determined probability of use, creating a valid set of unique tokens that are associated with the sentence string, and
linking verb sub-components associated with one or more of the unique tokens in the valid set of unique tokens to a pre-defined limited sub-set of verbs to create an identification tuple that maps onto the sub-set of verbs.

2. The method of claim 1 further including the steps of retrieving a document via a document retrieval interface, and analysing the contents of the document to determine sentence strings within the document.

3. The method of claim 2, wherein the document retrieval interface is one of a document server, a scanner, an e-mail interface, a peer to peer interface, and a file transfer protocol interface.

4. The method of claim 2, wherein the step of analysing the document to determine sentence strings includes the step of detecting at least one of a full stop, capital letter, comma, semi-colon, colon or question mark.

5. The method of claim 2, further including the steps of converting the retrieved document to at least one of an HTML and XHTML format prior to analysing the document contents to determine sentence strings.

6. The method of claim 2, wherein the step of analysing the contents of the document to determine sentence strings further includes the step of first analysing the contents of the document to determine textual information.

7. The method of claim 1, wherein the step of analysing the sentence string to determine sub-components includes the step of detecting at least one of an anaphora and a conjunction.

8. The method of claim 1, wherein a sub-component is a single part of speech.

9. The method of claim 8, wherein the single part of speech is a single word.

10. The method of claim 8, wherein the single part of speech is a group of words considered to be a single part of speech.

11. The method of claim 1, wherein the step of assigning one or more unique tokens to a sub-component includes the step of determining a probability of use for the syntactic or semantic use of the sub-component.

12. The method of claim 11, wherein the syntactic use determination includes the steps of searching for the sub-component in a set of pre-stored sub-component records, and, upon finding a pre-stored sub-component record that is associated with the sub-component,
assigning a unique token that is associated with the found pre-stored sub-component record.

13. The method of claim 1, wherein the step of determining a probability of use includes the step of determining the semantic or syntactic use of the sub-component.

14. The method of claim 13, wherein the step of determining the semantic or syntactic use of the determined sub-component includes the step of analysing further sub-components that surround the determined sub-component to determine a probability of use of the determined sub-component by analysing a set of pre-stored sub-component records to determine if the further sub-components are related to the determined sub-component.

15. The method of claim 14, wherein the pre-stored sub-component records include at least one of synonyms, semantic markers, semantic verbs and lexical relationships associated with the determined sub-component.

16. The method of claim 15, wherein the lexical relationships include at least one of synonyms, hypernyms, meronyms, antonyms, holonyms, hyponyms and instances of the determined sub-component.

17. The method of claim 13, wherein the step of determining the semantic use of the determined sub-component includes the step of determining a probability of use by determining and analysing further sentence strings within the textual information to find further sentence strings that are relevant to the sentence string.

18. The method of claim 17 further including the step of determining a probability of use based on the distance between the determined relevant further sentence strings and the sentence string.

19. The method of claim 13, wherein the step of determining the semantic use of the determined sub-component includes the step of determining a probability of use by determining the likely subject matter of a document in which the sentence strings are located.

20. The method of claim 13, wherein the step of determining the semantic use of the determined sub-component includes the step of determining a probability of use by retrieving a pre-determined probability of use based on an analysed training set of data.

21. The method of claim 1 further including the step of storing the identification tuple.

22. The method of claim 1 further including the step of inserting a reference to one or more sentence strings in the identification tuple.

23. The method of claim 1, wherein a multiple-to-multiple relationship is created between a plurality of identification tuples when the identification tuples are associated with the same or similar sentence strings.

24. The method of claim 1 further including the step of applying rules to the identification tuple to take into account common sense knowledge based on everyday usage of language.

25. The method of claim 1 further including the step of determining an invalid sentence string analysis that does not provide a resultant set of unique tokens within a predefined probability of use.

26. The method of claim 25 further including the step of logging information to identify the invalid sentence structure and enabling the invalid sentence structure to be reviewed.

27. The method of claim 26 further including the step of displaying the invalid sentence structure and enabling the sentence structure to be manually corrected.

28. The method of claim 26 further including the step of displaying the invalid sentence structure and enabling a set of unique tokens to be manually assigned to sub-components of the sentence structure.

29. The method of claim 26 further including the step of displaying the sub-components of the invalid sentence structure and enabling the sub-component to be categorised syntactically or semantically.

30. The method of claim 1 wherein the sentence string analysis further includes the steps of determining statistical information within the sentence string.

31. The method of claim 30, wherein the statistical information determined is used in conjunction with further statistical information and statistical analysis functions to output statistically based results.

32. The method of claim 1 wherein the sentence strings form at least part of a natural language search query.

33. The method of claim 32, further including the steps of creating a search query identification tuple from the search query, and comparing the search query identification tuple against one or more further identification tuples to find answers to the search query.

34. The method of claim 33, wherein the one or more further identification tuples are created at the time the natural language search query is made.

35. The method of claim 33, wherein the one or more further identification tuples are stored based on analysis carried out on textual information prior to the natural language search query being made.

36. The method of claim 33, wherein the step of comparing includes the step of finding a link between verbs or nouns in the search query identification tuple and verbs or nouns in the one or more further identification tuples.

37. The method of claim 36, wherein the verbs or nouns in the search query identification tuple and further identification tuples are linked through a lexicon data entry that associates a limited sub-set of verb and noun synonyms for each verb.

38. The method of claim 36, wherein the step of comparing includes the step of calculating a rank value based on the link and the tense of the verbs in the search query identification tuple and the one or more further identification tuples.

39. The method of claim 36, wherein the step of comparing includes the steps of determining how many common parameters exist in the search query identification tuple and the one or more further identification tuples, and calculating a rank value based on the number of common parameters.

40. The method of claim 36, wherein the step of comparing includes the steps of determining how linguistically close the parameters within the search query identification tuple and the one or more further identification tuples relate, and calculating a rank value based on the closeness of the relationship.

41. The method of claim 33, wherein the search query identification tuple is analysed to determine which part of the tuple the answer to the query relates.

42. The method of claim 1 further including the step of utilising the identification tuple to automatically assign one or more classifications to the textual information.

43. The method of claim 1 wherein the textual information is retrieved from a pre-defined external source, and the method further includes the steps of:
monitoring textual data output by the external source to identify pre-defined words or sentences associated with pre-defined subject matter, and
analysing any detected pre-defined words or sentences to create the identification tuple.

44. The method of claim 1, whereupon determination that the determined sub component has more than one meaning the method further includes the step of assigning probability weightings to each meaning.

45. The method of claim 1 further including the steps of performing syntactic analysis on the sub-components to determine probabilities that the sub component is a particular part of speech, and subsequently performing semantic analysis to determine the semantics of the sub-component.

46. The method of claim 1 wherein the sub-set of verbs is a set of verbs related to a sub-component that is a verb.

47. The method of claim 1 further including the step of:
linking noun sub-components associated with one or more of the unique tokens in the valid set of unique tokens to a pre-defined limited sub-set of nouns to create an identification tuple that maps onto the sub-set of nouns.

48. The method of claim 47 wherein the sub-set of nouns is a set of homonyms related to a sub-component that is a noun.

49. A natural language processing system including:
a text processing module arranged to analyse a sentence string within textual information to determine sub-components of the sentence string,
a parsing and semantic processing module arranged to assign one or more unique tokens to each determined sub-component, determine a probability of use that a determined sub-component has one or more specific meanings, and based on the determined probability of use, create a valid set of unique tokens that are associated with the sentence string, and a lexicon module arranged to contain links for each verb sub-component such that each link associates a verb sub-component with a pre-defined limited sub-set of verbs to enable the parsing and logic module to create an identification tuple that maps onto the sub-set of verbs.

50. The system of claim 49 further including an interface module and an inference engine, wherein the system is arranged and configured to retrieve a document via a document retrieval interface, and analyze the contents of the document to determine sentence strings within the document.
